(19) United States
(12) Patent Application Publication
(10) Pub. No.: US 2012/0292460 A1
(43) Pub. Date: Nov. 22, 2012

(54) Organizing device for cable and wire

(75) Inventor: Hsiu Li Hsu, I Lan (TW)

(73) Assignee: Wanho T Manufacturing Co., Ltd.

(21) Appl. No.: 13/068,793

(22) Filed: May 19, 2011

(51) Int. Cl. F16L 3/08

(52) U.S. Cl. 248/70; 248/65

(57) ABSTRACT

An organizing device includes a cylindrical retainer member made of a resilient material and having one or more longitudinal grooves, and having one or more slots formed in an outer peripheral portion and communicative with the grooves for engaging a cable through the slot and into each of the grooves of the cylindrical retainer member, and a coupling member engaged with the cylindrical retainer member for coupling and attaching the cylindrical retainer member to a supporting facility. The cylindrical retainer member is made of a resilient material for retaining the cables to the cylindrical retainer member.

### BACKGROUND OF THE INVENTION

1. Field of the Invention

The present invention relates to an organizing device, and more particularly to a cable and wire organizing device including an improved structure for allowing the cables and the wires to be easily and quickly engaged into the organizing device and to be easily and quickly attached or mounted or secured to various supporting facilities with the organizing device.

2. Description of the Prior Art

Typical cable organizing devices comprise a back mounting block for attaching or mounting or securing to various supporting apparatuses or facilities, the back mounting block includes a number of slots formed therein for receiving or engaging with the cables and the wires, and a front cap attached or mounted or secured to the back mounting block for clamping and retaining the cables and the wires between the back mounting block and the front cap.

For example, U.S. Pat. No. 5,167,388 to Blair, and U.S. Pat. No. 6,736,669 to Martin et al. disclose two of the typical cable organizing devices each comprising a front part and a rear part including a number of slots formed therein for receiving or engaging with the cables and the wires, and a bracket attached or mounted or secured to the rear part for clamping and retaining the cables and the wires between the bracket and the rear part.

However, the front caps and the brackets should be removed and separated from the back mounting blocks and the rear parts before the cables and the wires may be disposed or attached or engaged into the slots that are formed between the back mounting block and the front cap or between the bracket and the rear part.

U.S. Pat. No. 7,607,618 to Mori et al. discloses another typical cable organizing device comprising a cable clip with a rigid circular base and a flexible dome-shaped head, and the base includes a central aperture and an adhesive layer covered by a protective file on one side, and the dome-shaped head includes a number of slots that extend radially across the head and interest with one another.

However, the dome-shaped head may not stably anchor and retain the cables and the wires to the dome-shaped head, and the cables and the wires may have a good chance to be disengaged from the dome-shaped head.

The present invention has arisen to mitigate and/or obviate the afore-described disadvantages of the conventional cable and wire organizing devices.

### SUMMARY OF THE INVENTION

The primary objective of the present invention is to provide a cable organizing device including an improved structure for allowing the cables and the wires to be easily and quickly engaged into the organizing device and to be easily and quickly attached or mounted or secured to various supporting facilities with the organizing device.

In accordance with one aspect of the invention, there is provided a cable organizing device comprising a cylindrical retainer member made of a resilient material and including at least one groove longitudinally formed therein, and including at least one slot formed in an outer peripheral portion thereof and communicative with the groove of the cylindrical retainer member for engaging a cable through the slot and into the groove of the cylindrical retainer member, and a coupling member engaged with the cylindrical retainer member for coupling and attaching the cylindrical retainer member to a supporting facility.

The cylindrical retainer member includes an engaging member formed in the outer peripheral portion of the cylindrical retainer member for engaging with the coupling member. The cylindrical retainer member includes at least one flange for forming the engaging member and for engaging with the coupling member.

The cylindrical retainer member includes at least one orifice longitudinally formed therein and separated from the groove of the cylindrical retainer member, and includes at least one second slot formed in the outer peripheral portion of the cylindrical retainer member and communicative with the orifice of the cylindrical retainer member.

The cylindrical retainer member includes a slit formed therein and communicative with the orifice and the groove of the cylindrical retainer member. The orifice and the groove of the cylindrical retainer member include different inner diameters for receiving and engaging with cables of different outer diameters.

The coupling member includes two curved holders having a compartment formed between the curved holders for receiving and engaging with the cylindrical retainer member. The coupling member includes an open end for attaching to the supporting facility with a fastening device.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view illustrating an attachment of a cable organizing device in accordance with the present invention onto a supporting facility;

FIG. 2 is a partial exploded view of the cable organizing device;

FIG. 3 is a perspective view of the cable organizing device;

FIGS. 4 and 5 are partial perspective views illustrating the operation of the cable organizing device;

FIGS. 6 and 7 are partial perspective views illustrating the other arrangement of the cable organizing device;

FIG. 8 is a top plan schematic view illustrating the operation of the cable organizing device as shown in FIGS. 6-7;

FIGS. 9, 10, 11, 12, 13, 14 are perspective views illustrating the operation of the cable organizing device;

FIGS. 15, 16, 17, 18 are perspective views illustrating the further arrangement of the cable organizing device; and

FIGS. 19, 20, 21 are perspective views illustrating the further arrangement of the cable organizing device.

### DETAILED DESCRIPTION OF THE PREFERRED EMBODIMENT

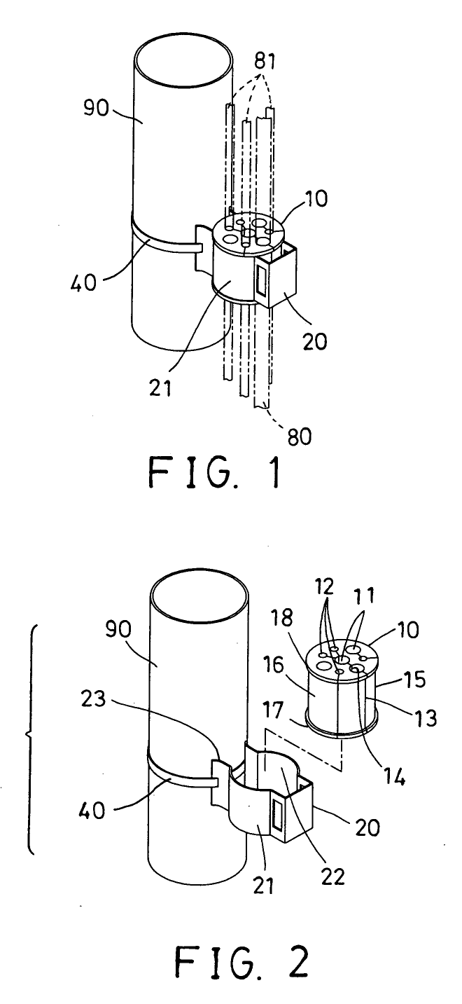

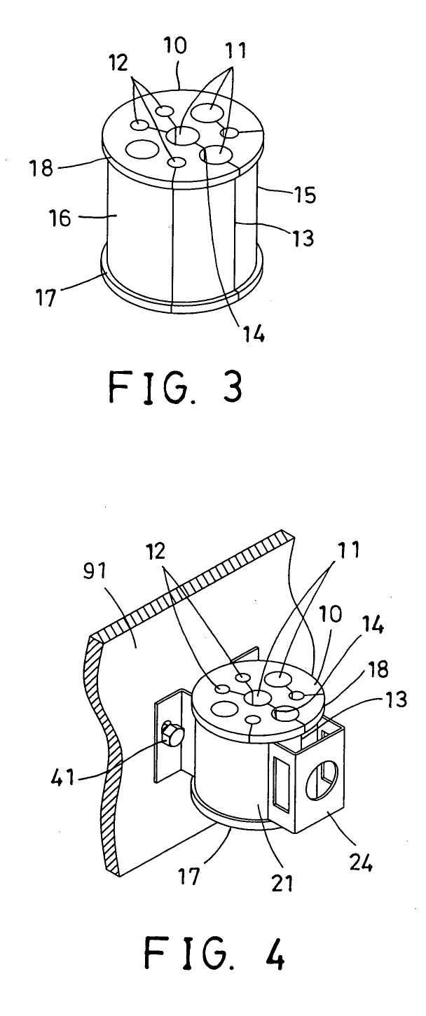

Referring to the drawings, and initially to FIGS. 1-3, a cable organizing device in accordance with the present invention comprises a cylindrical retainer body or member 10 including one or more channels or grooves 11 longitudinally formed therein and separated or spaced from each other, and further including one or more apertures or orifices 12 also longitudinally formed therein and separated or spaced from each other and also separated or spaced from the grooves 11 of the cylindrical retainer member 10, and including a slot 13 formed in the outer peripheral portion 15 thereof and intersecting or communicative with either of the grooves 11 or the orifices 12 that are located at the outer peripheral portion 15 of the cylindrical retainer member 10 for allowing the cables 80 and the wires 81 (FIG. 1) to be easily and quickly engaged through the slots 13 and then engaged into the grooves 11 and the orifices 12 of the cylindrical retainer member 10 of the organizing device. The cylindrical retainer member 10 is made of soft or resilient rubber or plastic materials for allowing the cables 80 and the wires 81 to be easily and quickly engaged through the slots 13 and then engaged into the grooves 11 and the orifices 12 of the cylindrical retainer member 10. The grooves 11 and the orifices 12 of the cylindrical retainer member 10 include different inner diameters for receiving and engaging with the cables 80 and the wires 81 of different outer diameters.

The cylindrical retainer member 10 may further include one or more slits 14 formed therein and intersecting or communicating the grooves 11 and/or the orifices 12 with each other for allowing the cables 80 and the wires 81 to be engaged into the grooves 11 and the orifices 12 at the middle or central portion of the cylindrical retainer member 10. The cylindrical retainer member 10 further includes an engaging member 16, such as an outer peripheral depression or recess 16 formed in the outer peripheral portion 15 thereof and formed or defined by and between a lower and outer peripheral flange 17 and/or an upper and outer peripheral flange 18 for engaging with a coupling member 20, such as a coupling barrel or sleeve 20 and for solidly and stably anchoring or securing or retaining the coupling member 20 to the cylindrical retainer member 10 and for preventing the coupling member 20 from being disengaged from the cylindrical retainer member 10. It is to be noted that the cylindrical retainer member 10 may resiliently engage with the cables 80 and the wires 81 for solidly and stably anchoring or securing or retaining the cables 80 and the wires 81 in the cylindrical retainer member 10.

For example, the coupling member 20 includes two curved holders 21 having a compartment 22 formed or defined between the curved holders 21 for suitably receiving or engaging with the cylindrical retainer member 10 and for solidly and stably anchoring or securing or retaining the coupling member 20 in or with the engaging member 16 of the cylindrical retainer member 10, and includes an open end 23 for allowing the cylindrical retainer member 10 to be easily and quickly engaged into the compartment 22 of the coupling member 20 that is formed or defined between the curved holders 21, and for allowing the cylindrical retainer member 10 and the coupling member 20 to be easily and quickly attached or mounted or secured to various supporting apparatuses or facilities 90 with a coupling or fastening device 40, such as a fastening strap 40.

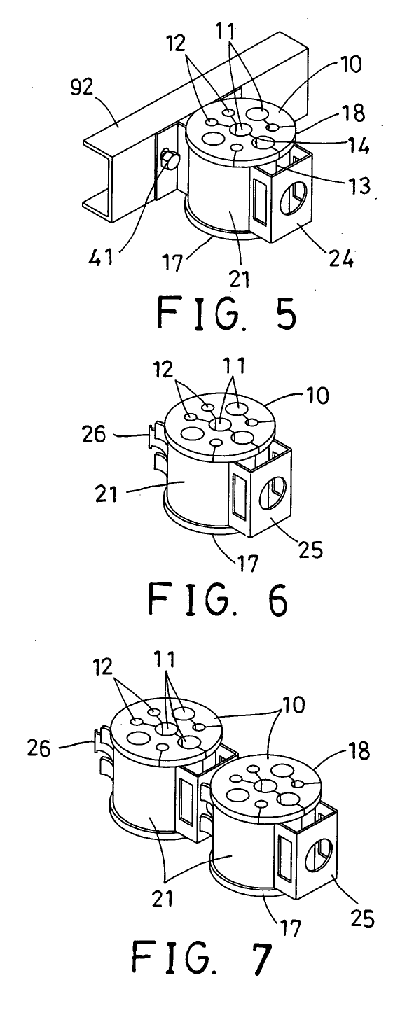

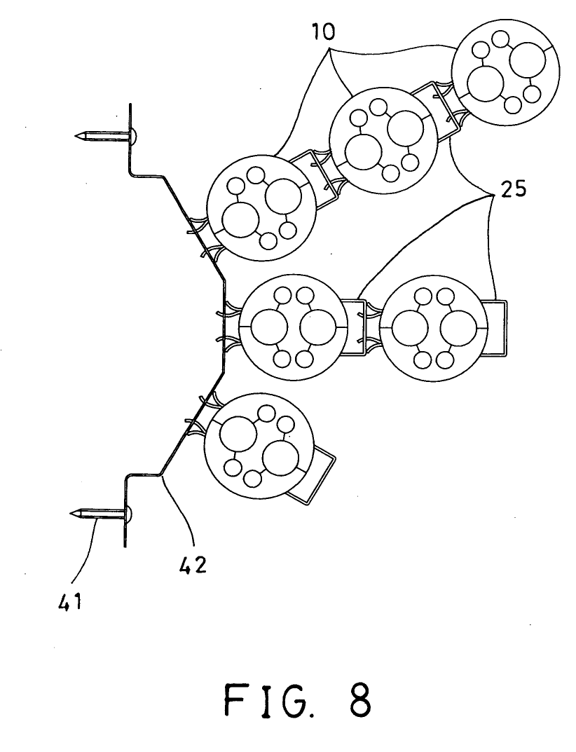

As shown in FIGS. 4 and 5, the cylindrical retainer member 10 and the coupling member 24 may also be easily and quickly attached or mounted or secured to the other supporting apparatuses or facilities 91, 92 with the other coupling or fastening devices 41, such as the screws or fasteners 41. As shown in FIGS. 6-8, the coupling members 25 may include a latching member 26 for connecting or coupling two or more coupling members 25 together and for connecting or coupling the coupling members 25 and the cylindrical retainer member 10 to the other fastening devices 42, such as a fastening strap 42, and then to the other supporting apparatuses or facilities with screws or fasteners 41.

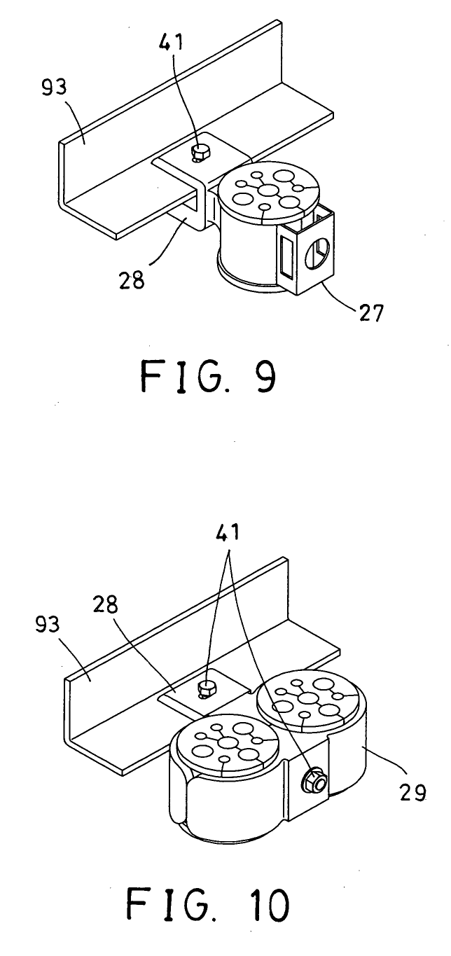

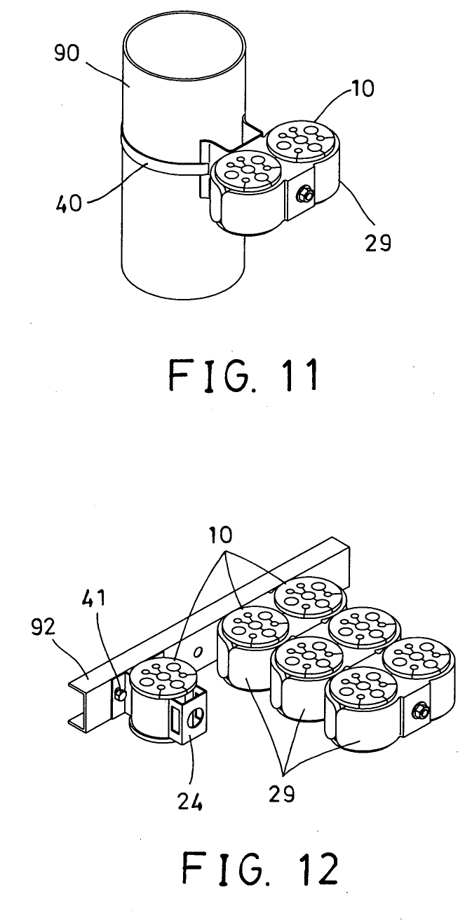

Alternatively, as shown in FIGS. 9-10, the coupling members 27, 29 each may include an attaching member 28 for connecting or coupling one or more cylindrical retainer members 10 to the other supporting apparatuses or facilities 93 with the other coupling or fastening devices 41, such as the screws or fasteners 41. As shown in FIG. 11, the coupling member 29 may also be easily and quickly attached or mounted or secured to the supporting apparatuses or facilities 90 with the coupling or fastening device 40, such as the fastening strap 40. As shown in FIG. 12, the cylindrical retainer members 10 and the coupling members 24, 29 may also be easily and quickly attached or mounted or secured to the other supporting apparatuses or facilities 92 with the other coupling or fastening devices 41, such as the screws or fasteners 41.

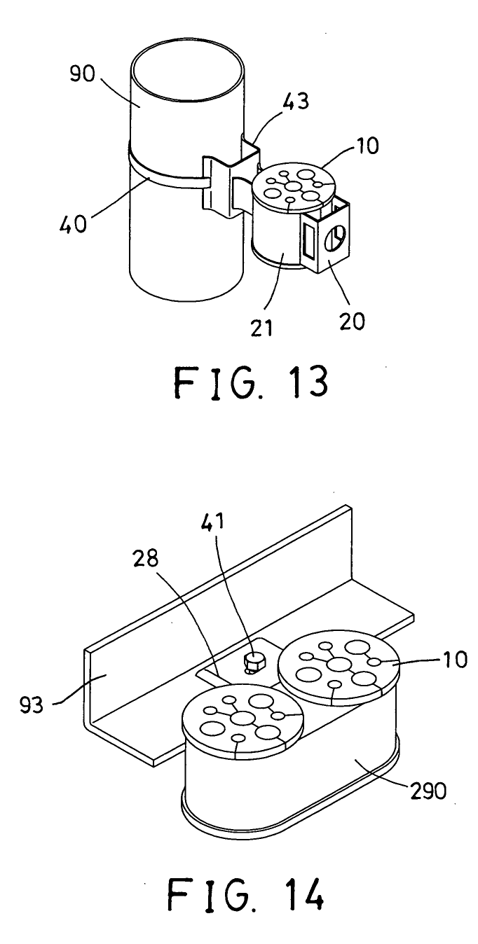

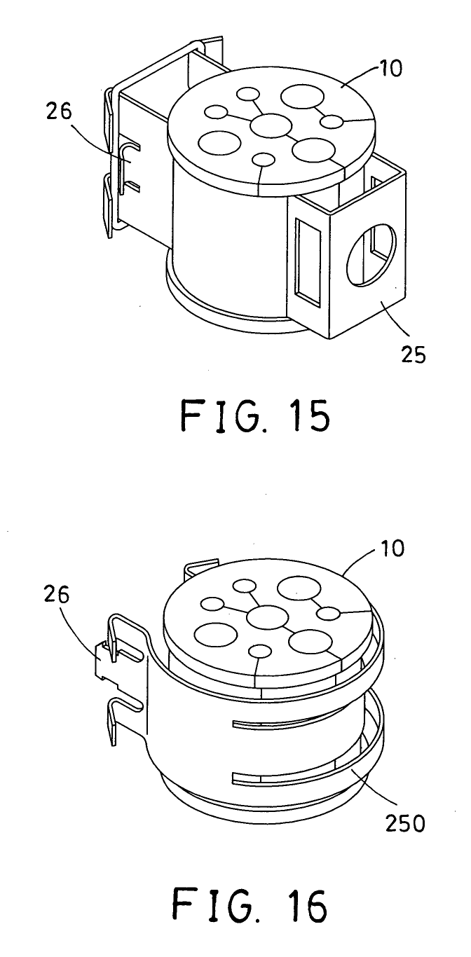

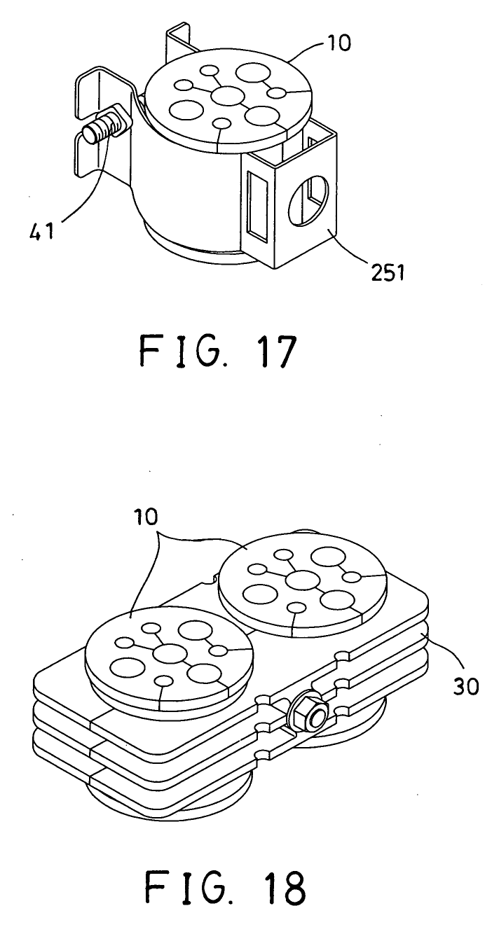

As shown in FIG. 13, the cylindrical retainer members 10 and the coupling member 20 may also be easily and quickly attached or mounted or secured to the supporting apparatuses or facilities 90 with the coupling or fastening device or strap 40 and a bracket 43. As shown in FIG. 14, the cylindrical retainer members 10 and the coupling member 290 may also be easily and quickly attached or mounted or secured to the other supporting apparatuses or facilities 93 with the other coupling or fastening devices 41, such as the screws or fasteners 41 and the attaching member 28. As shown in FIGS. 15-17, the coupling members 25, 250, 251 may include a latching member 26 or a screw or fastener 41.for coupling to the other coupling members or the other supporting apparatuses or facilities.

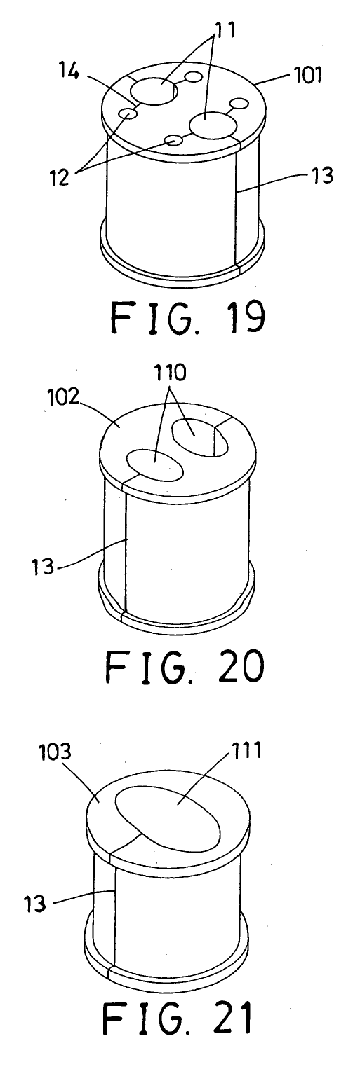

As shown in FIG. 18, the cylindrical retainer members 10 may also be easily and quickly attached or mounted or secured together with the other coupling member 30, such as the coupling housing member 30. Alternatively, as shown in FIGS. 19-21, the cylindrical retainer members 101, 102, 103 may include different number of the grooves 11 and the orifices 12, or may include the grooves 110, 111 of different shapes or contours. It is to be noted that the cables 80 and the wires 81 may be easily and quickly engaged through the slots 13 and then engaged into the grooves 11 and the orifices 12 of the cylindrical retainer member 10 of the organizing device and may be easily and quickly attached or mounted or secured to various supporting apparatuses or facilities 90, 91, 92, 93 with the coupling or fastening devices 40, 41, 42.

Accordingly, the cable organizing device in accordance with the present invention includes an improved structure for allowing the cables and the wires to be easily and quickly engaged into the organizing device and to be easily and quickly attached or mounted or secured to various supporting facilities with the organizing device.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. An organizing device comprising:
a cylindrical retainer member made of a resilient material and including at least one groove longitudinally formed therein, and including at least one slot formed in an outer peripheral portion thereof and communicative with said at least one groove of said cylindrical retainer member for engaging a cable through said at least one slot and into said at least one groove of said cylindrical retainer member, and
a coupling member engaged with said cylindrical retainer member for coupling and attaching said cylindrical retainer member to a supporting facility.

2. The organizing device as claimed in claim 1, wherein said cylindrical retainer member includes an engaging member formed in. said outer peripheral portion of said cylindrical retainer member for engaging with said coupling member.

3. The organizing device as claimed in claim 1, wherein said cylindrical retainer member includes at least one flange for forming said engaging member and for engaging with said coupling member.

4. The organizing device as claimed in claim 1, wherein said cylindrical retainer member includes at least one orifice longitudinally formed therein and separated from said at least one groove of said cylindrical retainer member, and includes at least one second slot formed in said outer peripheral portion of said cylindrical retainer member and communicative with said at least one orifice of said cylindrical retainer member.

5. The organizing device as claimed in claim 4, wherein said cylindrical retainer member includes a slit formed therein and communicative with said at least one orifice and said at least one groove of said cylindrical retainer member.

6. The organizing device as claimed in claim 4, wherein said at least one orifice and said at least one groove of said cylindrical retainer member include different inner diameters for receiving and engaging with cables of different outer diameters.

7. The organizing device as claimed in claim 1, wherein said coupling member includes two curved holders having a compartment formed between said curved holders for receiving and engaging with said cylindrical retainer member.

8. The organizing device as claimed in claim 1, wherein said coupling member includes an open end for attaching to the supporting facility with a fastening device.
